(19) United States
(12) Patent Application Publication
(10) Pub. No.: US 2015/0001842 A1
(43) Pub. Date: Jan. 1, 2015

(54) Multi-Axis Hose Connector Assembly

(71) Applicants: Marvin W. Jones, Santa Rosa, CA (US); Teresa Lee Jones, Santa Rosa, CA (US)

(72) Inventors: Marvin W. Jones, Santa Rosa, CA (US); Teresa Lee Jones, Santa Rosa, CA (US)

(21) Appl. No.: 14/315,934

(22) Filed: Jun. 26, 2014

Related U.S. Application Data
(60) Provisional application No. 61/839,416, filed on Jun. 26, 2013.

(51) Int. Cl. F16L 27/047

(52) U.S. Cl. CPC F16L 27/047
USPC 285/261

(57) ABSTRACT

A multi-axis hose connector is provided. The assembly comprises a first and second hose connector end secured to a first and second housing. The housings and the inner end of each connector end support a captive ball therein, where the captive balls form a first and second ball joint that permits the connector ends to freely swivel and pivot relative to one another. Between the ball joints is an elongated tube member having open ends and an open interior. The tube member secures to the captive balls and aligns with an open conduit therethrough, while each of the housings and connector ends include an open interior. The open interior of the tube member, captive balls, housings, and end connectors form a continuous conduit through which fluid flows, despite the angular position of the assembly. In this way, the assembly provides a unique hose connector with several degrees of freedom.

### CROSS REFERENCE TO RELATED APPLICATION

This application claims the benefit of U.S. Provisional Application No. 61/839,416 filed on Jun. 26, 2013. The above identified patent application is herein incorporated by reference in its entirety to provide continuity of disclosure.

### BACKGROUND OF THE INVENTION

1. Field of the Invention

The present invention relates to hose connectors and swivel joints. More specifically, the present invention relates to a freely rotating, dual swivel joint connection for a water hose, whereby water flow therethrough is accommodated and the connection prevents kinking in the water hose while maximizing positioning thereof.

Hose connectors are present in the art and include various structures for coupling two or more members to facilitate flow of gas or water therebetween and through the connector. These connectors include those that support members in a static relationship, whereby the connected members are fixed to one another when joined by the connector. Others permit the two connected members to articulate relative to one another when joined, whereby one member may exhibit at least one degree of freedom while maintaining a fluid connection with a second member. The design and arrangement of these connectors vary depending upon the type of fluid, the application, and the desired flexibility of the joint. Common joined members include water hose and nozzle connections, joined lengths of hose, and hose connections to a fluid supply.

The goal of articulating hose connectors is to allow the user to manipulate and handle the hose without causing kinking or twisting of the line, which can interrupt flow, create excessive internal pressure, and also stress the hose itself. Many common hose connectors in the art permit a singular degree of freedom between the connected members. These connectors largely include those that facilitate rotation along the central axis of the hose, whereby relative spinning of one member in reference to another is facilitate without breaking connectivity between the adjacent members (for instance, between a garden hose and a nozzle). However, while this configuration is well described in the art, these connectors lack the ability to accommodate pivoting or bending of the members relative to one another. Bending of the connection between adjacent members is common in water hoses, particularly when a water supply is directed at a sharp angle relative to the hose central axis.

The present invention addresses this need in the art by providing a water hose connector assembly that accommodates several degrees of freedom, whereby pivoting and swiveling capability are provided at two ball joint locations within the connector. The assembly comprises a first and second connector end joined to a housing that supports a captive ball joint. A tube member extends between the ball joints, while the housings and the connector ends comprise an open interior whereby fluid can pass through the entire assembly. The ball joints support relative rotation of the two housing (spinning), and furthermore support pivoting of the assembly into at least a ninety-degree angle. In this way, a user can pivot one connected member at a sharp angle relative to another, and furthermore spin the two members relative to one another without kinking, compressing or stressing the two members in the process.

2. Description of the Prior Art

Devices have been disclosed in the prior art that relate to hose connectors. These include devices that have been patented and published in patent application publications. These devices generally relate to hose connectors that provide a joint that facilitates a singular degree of freedom. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 5,816,624 to Smith, which discloses a swivel connector for a hose end that allows rotation of the connected hose relative to another adjacent hose, whereby the first hose can rotate along its center axis relative to the adjacent hose. The device comprises a housing having a ball bearing assembly, wherein the ball bearing assembly allows rotation of a nipple coaxially disposed with the housing. Seals and thrust plates are also provided to prevent leaking of fluid from the connector device. While the Smith device allows for rotation of a hose relative to an adjacent hose or a water supply, the Smith device is limited to a single degree of rotation: rotation about its center axis. The present invention discloses a hose connector that allows for both swiveling and pivoting, whereby a first and second ball joint connection allow two adjacent hoses (or a single hose relative to a static connection) to both swivel and pivot to prevent kinking or twisting of the hose during use. The present invention increases the flexibility of the hose and allows for additional degrees of freedom.

Similar to the Smith device is U.S. Pat. No. 5,507,535 to McKamey, which discloses a conduit swivel connector having a pair of truncated conical tube portions extending away from one another that are adapted to support sleeves that can connect to hose ends. The conical tube portions abut against one another at a flange, while the sleeves are rotatably mounted to each conical tube portion. Annular grooves along the exterior surface of the sleeves retain the attached hoses, while the rotatable connection between the sleeves and conical tube portions allow relative rotation of the two hoses connected to the assembly. Similar to Smith, the McKamey device is limited to a single degree of freedom. Furthermore, McKamey does not provide a threaded hose connection, but rather includes raised grooves that retain hose ends on the sleeve portions.

U.S. Pat. No. 5,671,954 to Cheramie discloses a swivel connector for a garden hose that central tubular portion, sealing flanges and outer sealing surfaces to prevent leakage. The Cheramie facilitates rotation of a garden hose or attachment thereon; however as with other devices in the art, the Cheramie fails provide a structure that rotates and pivots as provided herein. The present invention provides several degrees of freedom: a pivoting rotation and a swiveling rotation at each hose attachment location. This permits connected members to be disposed at extreme angles relative to one another without kinking or twisting.

The present invention provides a connector that exhibits several degrees of freedom, whereby two captive ball joints, a central conduit, and two ends allow the connector to swivel and to pivot relative to the connected members at its ends. This allows users to radically maneuver a hose relative to another connected member, such as a hose nozzle, another adjacent hose, or a water supply connection. The user can direct fluid flowing between the members at these extreme angles without causing any pinching, kinking, or twisting of the members in the process.

Overall, it is submitted that the present invention is substantially divergent in design elements from the prior art, and consequently it is clear that there is a need in the art for an improvement to existing hose connector devices. In this regard the instant invention substantially fulfills these needs.

### SUMMARY OF THE INVENTION

In view of the foregoing disadvantages inherent in the known types of hose connectors now present in the prior art, the present invention provides a new swiveling and pivoting hose connector that can be utilized for providing convenience for the user when rotating and angling a hose without causing pinching, kinking, or stretching of the hose.

It is therefore an object of the present invention to provide a new and improved hose connector device that has all of the advantages of the prior art and none of the disadvantages.

It is another object of the present invention to provide a hose connector device that includes a double-sided connector and a pair of ball joints that allow for several degrees of freedom between two connected members.

Another object of the present invention is to provide a hose connector device that pivotably and swivellly joins a first and second member, and further permits the free flow of fluid through the connector such that the device can be used as a hose connector.

Yet another object of the present invention is to provide a hose connector device that includes a first and second removably attached end connector that attaches to the ball joint housings of the assembly, whereby a male, female, or any end connector combination thereof is accommodated.

Another object of the present invention is to provide a hose connector device that comprises an elongated tube connector having nozzle ends disposed within a first and second captive ball, whereby the nozzle ends allow fluid to flow from the connector ends and through the assembly in any angular configuration or orientation of the connector assembly.

Another object of the present invention is to provide a hose connector device that allows the user to angle, pivot, or rotate one connected member relative to another connected member without causing pinching, kinking, or bending of the members.

A final object of the present invention is to provide a hose connector device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the connector assembly of the present invention.

FIG. 2 shows another perspective view of the connector assembly of the present invention.

FIG. 3 shows a side view of the connector assembly of the present invention.

FIG. 4 shows a front view of the connector assembly of the present invention.

FIG. 5 shows a rear view of the connector assembly of the present invention.

FIG. 6 shows cross section view of the connector assembly.

### DETAILED DESCRIPTION OF THE INVENTION

Reference is made herein to the attached drawings. Like reference numerals are used throughout the drawings to depict like or similar elements of the multi-axis hose connector assembly of the present invention. For the purposes of presenting a brief and clear description of the present invention, the preferred embodiment will be discussed as used for connecting two members and communicating fluid through a pivoting and swiveling connector assembly such that pinching, kinking, and bending of the two members is eliminated. The figures are intended for representative purposes only and should not be considered to be limiting in any respect.

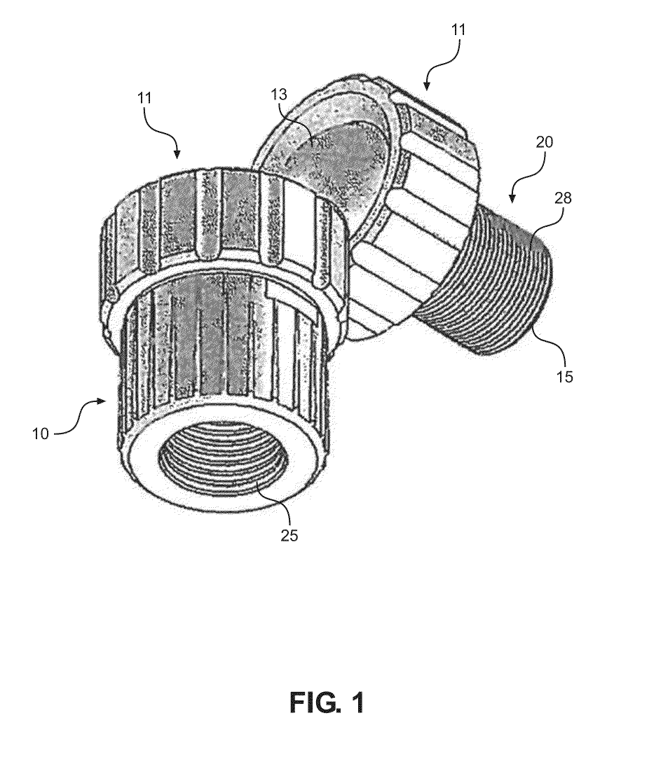

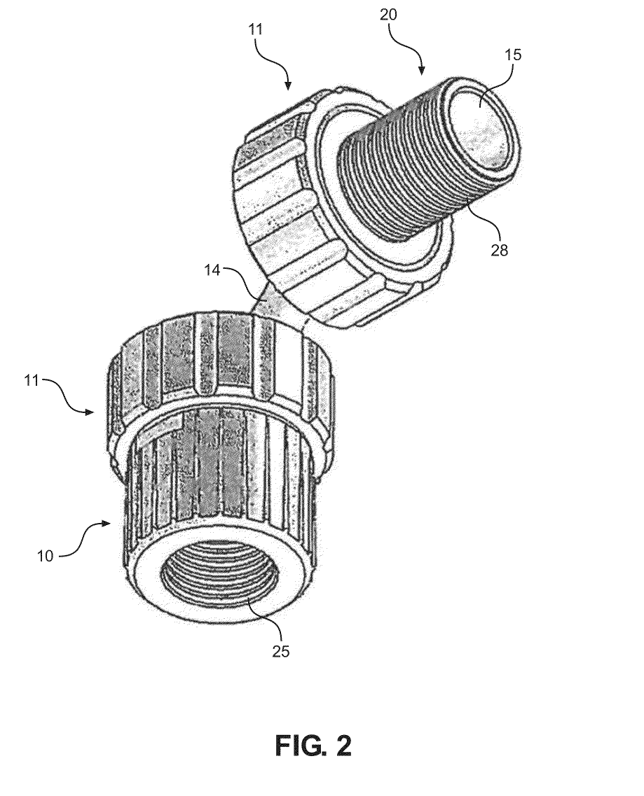

Referring now to FIGS. 1 and 2, there is illustrated two perspective views of the multi-axis hose connector assembly of the present invention. The assembly comprises a first 10 and second 20 hose connector end that connects to a first and second housing 11. The connector ends 10, 20 are end members that are adapted to fasten to hoses, valves, or other members and effectuate a fluid seal therewith. The preferred connection is one of a threaded connection, whereby the provided threads may be internal or external. As illustrated in the provided figures, the preferred configuration is a first connector end 10 with a female threaded end 25 to accept therethrough a male threaded member, while the second connector end 20 comprises a male threaded member end 15 with exterior threads 28. This allows the assembly to be secured inline between two hoses, a hose and a nozzle, or any other member in which male and female threads engage to create a fluid seal.

Disposed within the interior of each of the housings 11 is a captive ball 13, which is rotatably positioned within the interior of each housing 11 and within the inner end of each of the connector ends 10, 20. Each captive ball forms a ball joint with a center point located within the interior of each housing 11, whereby the assembly provides a first and second ball joint (spherical joint) such that the housings 11 and the connector ends 10, 20 can pivot, swivel, and rotate relative to one another. This allows the assembly to orient one connector end relative to another without kinking, pinching, or otherwise compromising the flow of fluid between connector ends or adjacent to the assembly (e.g. along a connected hose).

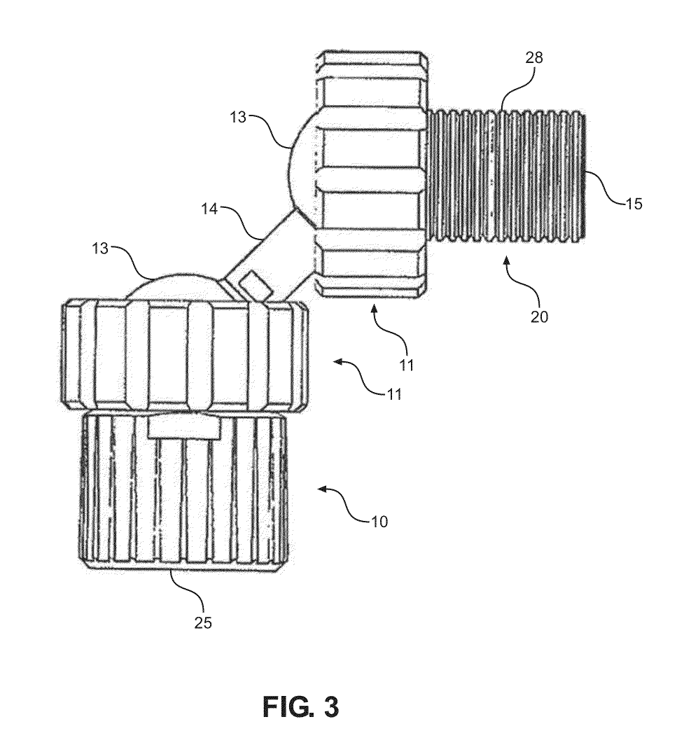

Joining the housings 11 together and forming the mid-body of the assembly is an elongated tube member 14, which includes a first and second end. The ends thereof are connected to the captive balls 13, whereby the housings 11 can rotate and swivel freely from the ends of the tube member 14. Referring to FIG. 3, there is shown a side view of the assembly, whereby the connection between the tube member ends and the two captive balls 13 is illustrated. The tube member 14 comprises an elongated length having an open interior and open ends disposed within the interior of each captive ball 13. Similarly, each captive ball 13 includes an open interior and a conduit therethrough. Together with the form open interior of the housings 11 and the connector ends 10, 20, the assembly provides a continuous, open conduit within which free and uninterrupted flow of fluid is accommodated at any given orientation of the assembly. Therefore, fluid flows from one end 25 to the opposite end 15 and through the interior of the assembly when the device is aligned, rotated, pivoted, or is actively being manipulated by the user.

It is contemplated that the connector ends 10, 20 may be provided in any combination, whereby a male threaded end may be provided in conjunction with a female threaded end, or alternatively two of the same connector types may be deployed (e.g. two male connector ends or two female connector ends). The male connector end 20 comprises a tubular body with exterior threads 28 and an open end 15. The female connector end 10 comprises an open end and a tubular body with interior threads. Furthermore, alternate types of connectors ends may be provided that do not utilize a threaded connection, such as quick release fittings, clamped connectors, and other hose connector types known to those skilled in the art of hose connectors.

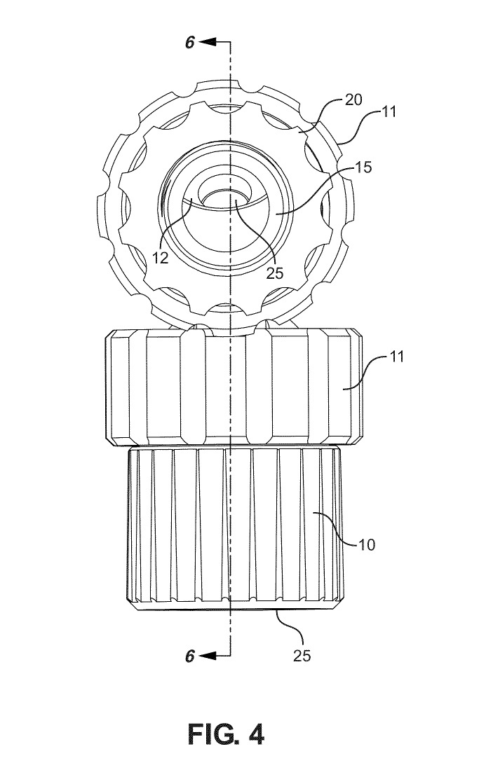

Referring now to FIG. 4, there is shown a front view of the multi-axis hose connector assembly of the present invention, illustrating open conduit through the assembly from the point of view of the open end 15 of the second connector end 20. The second connector end 20 connects and terminates at the housing 11, wherein the inner end of the connector end 20 and the housing 11 support a captive ball therein. The tube member 14 is secured at its end to the captive ball and provides an open interior 25 through which fluid can travel between the housings 11 and the first 10 and second 20 connector ends. The captive ball 13 furthermore comprises an open interior conduit that extends through the ball between a first open end and a second open end. In this way, fluid flows between the outer ends 25, 15 of the assembly and therethrough despite the orientation of each end relative to one another. The ends of the tube member are secured to the captive ball and comprise an open end, or alternatively comprise nozzle or diffuser ends. The ends are adapted to allow for the free communication of fluid from the tube, through the captive balls, and through the housings and connector ends. The exact design of the tube member ends 12 may take on several designs to optimize the goal of fluid flow through the assembly.

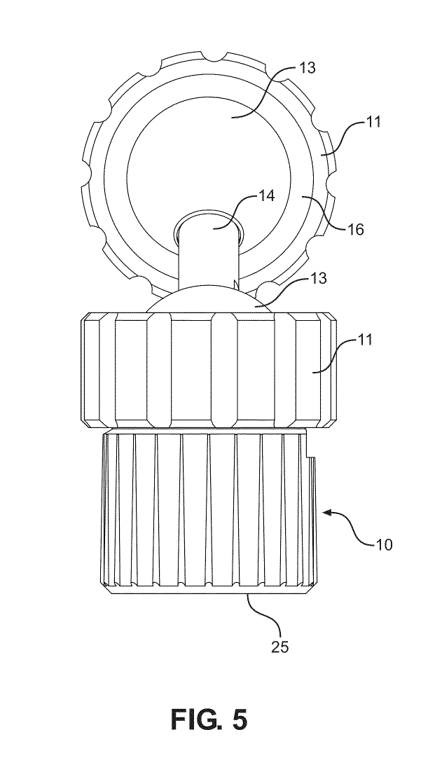

Referring now to FIG. 5, there is shown a rear view of the present invention, further illustrating the arrangement of the tube member 14 and captive balls 13 along the middle of the assembly. The captive balls 13 are supported within the open interior of each housing 11, whereby the balls 13 can each rotate freely therein within a given range of rotation. The rotation is about the center point of each captive ball 13 and allows the tube member 14 to pivot, swivel and rotate. Thus each connector end can be oriented relative the other as desired and within the given rotational range accommodated by the assembly.

Each of the captive balls 13 forms a ball joint (spherical joint), whereby a portion of each captive ball is exposed from the interior end of each housing. The housings 11 include an outer end and an inner end, the inner end having an opening with a given diameter so as to expose a portion of each captive ball 13 a sufficient amount to allow free rotation of the tube member 14 about the captive ball center point. The range of motion of each of the captive balls (spherical joints) is limited by the diameter of the inner end of each housing, whereby the tube member bears thereagainst at its extremes. The outer ends of each housing support threaded connections to the connector ends. The amount of rotation permitted by each of the ball joints is determined by the exposed surface area of each captive ball 13 along the inner end of each housing 11. The tube member 14 rotates freely within this range and at the outer extent of the allowable rotation abuts against the housing inner end. Therefore, the exposed surface area of each captive ball 13 determines the full range of rotation of the assembly, whereby the connector ends may be disposed at up to or greater than ninety degrees from one another (see FIG. 4).

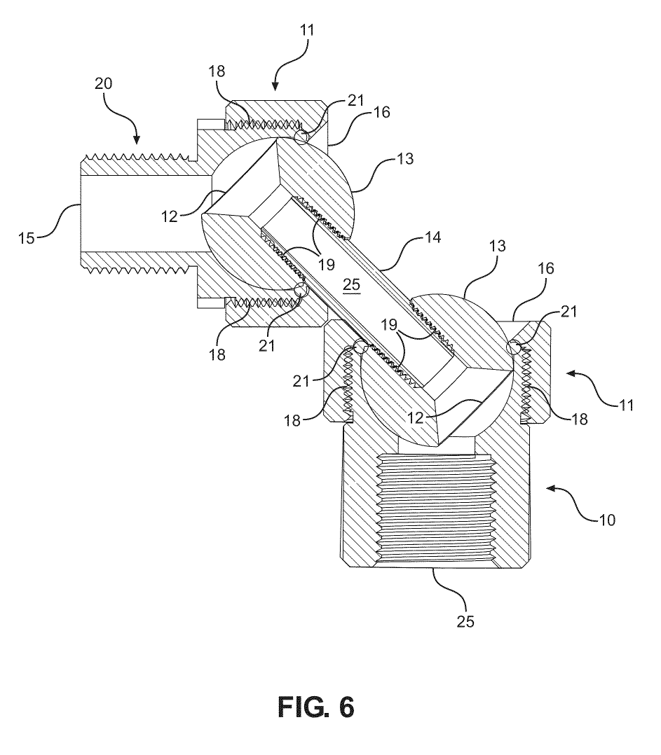

Referring finally to FIG. 6, there is shown a cross sectional view of the present invention. This configuration represents the preferred embodiment of the present invention, wherein each of the elements are threadably fastened to each other and provide a modular assembly whereby the chosen connector ends 10, 20 may be interchanged and updated as desired. The preferred embodiment will be discussed with a first female connector end 10 and a second male connector end 20; however any combination of male and female connector ends may be substituted, falling within the scope of the present invention.

The first connector end 10 comprises a female threaded member having an open outer end 25, an open interior within internal threads, and an open inner end threadably attached 18 to a first housing 11. The interior of the housing 11 and the inner end of the connector end 10 supports a first captive ball 13 therein. The captive ball 13 is free to rotate therein, whereby it is supported within an opening having minimal clearance such that rotation is permitted but relative translation is limited. Disposed along the inner end of the connector end 10 is a gasket 21, which seals the clearance between the captive ball 13 and the inner end of the connector end 10. This configuration is copied and mirrored along the second connector end 20, wherein the second captive ball 13 is rotatably supported therein and sealed using an annular gasket 21 or suitable O-ring.

Each captive ball 13 is a spherical member with an open interior extending therethrough. The open interior terminates at one end at a threaded opening 19, and at an open outlet 12 along the opposite end. The open outlet may be flared in the form of a diffuser or maintain the same cross section as the rest of the captive ball open interior. The open outlet 12 is sized such that when the tube member 14 is rotated to its fullest extent, the outlet 12 does not extend beyond the gasket 21, this prevents leakage when the assembly is angled or orientated by the user. The extent of rotation of the tube member 14 is defined by the tapered opening 16 of each housing 11, whereby a flared or tapering opening 16 is provided such that the outer surface of the tube member 14 can bear thereagainst when the device is manipulated, creating a physical stop that prevents over-rotation and risk of leakage.

FIG. 6 illustrates the assembly rotated to at its outer limit, whereby the first 10 and second 20 connector end are disposed in orthogonal or greater than ninety degree angles from one another. In this configuration, the extent of rotation of each captive ball 13 and the housing 11 design will dictate the outermost rotational limit. Each of the connectors can swivel in this configuration, and the free flow of fluid through the assembly is accommodated within its rotational range. As shown, the open interior of each connector end 10, 20 forms a continuous connection with the open interior of each captive ball 13, which in turn joins the open interior 25 of the tube member 14 to form a continuous, open conduit through the assembly at any angular disposition thereof.

Fluid hoses are used in many areas and for many different applications, including use in domestic settings, use in commercial and industrial settings, and use in emergency situations (e.g. fire and emergency responders). Fluid hoses are elongated, flexible members that allow fluid to flow therethrough while the user orients the hose and points it to a desired location. The hose can flex to accommodate this manipulation, however extreme positioning of the hose can cause kinking, twisting, and bending of the hose. This restricts fluid flow through the hose and increases pressure on the hose. The present invention is an assembly adapted to secure to a fluid hose and provide a multi-axis connector, whereby multiple hoses can be joined or a hose can be connected to another member (e.g. a nozzle, etc.) and orientation with respect thereto without kinking or otherwise compromising the water flow. The device comprises a dual ball joint configuration that includes several free degrees of rotation, whereby fluid can flow through the connector assembly when oriented at extreme angles. The preferred configuration comprises a plastic assembly with rubber O-rings, wherein the elements of the assembly are threadably connected to one another; however embodiments of the assembly construction may include combined portions that are not threadably attached, different material types other than plastic, and configurations that support different combinations of end connectors for different applications.

Overall it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multi-axis hose connector assembly, comprising:
a first connector end and a second connector end, each having an outer end, an inner end, and an open interior extending therethrough;
a first housing and a second housing, said first housing secured to said inner end of said first connector end and said second housing secured to said inner end of said second connector end;
said first housing and said second housing having an open outer end, an open inner end, and an open interior;
a first captive ball and a second captive ball, each captive ball having an internal conduit extending therethrough and between an inner open end and an outer open end;
said first captive ball being rotatably positioned within the inner end of said first connector end and retained therein by said first housing;
said second captive ball being rotatably positioned within the inner end of said second connector end and retained therein by said second housing;
a tube member having an elongated length, an exterior surface, and an open interior;
said tube member having a first end and a second end;
said first end of said tube member securing to the inner open end of said first captive ball;
said second end of said tube member securing to the inner open end of said second captive ball;
said first captive ball and said second captive ball each forming a ball joint location with a center point and a range of motion;
the open interior of said first connector end, the open interior of said first housing, the internal conduit of said first captive ball, the open interior of said tube member, the internal conduit of said second captive ball, the open interior of said second housing, and the open interior of said second connector end all forming a continuous and sealed conduit within said range of motion of both said first captive ball and said second captive ball.

2) The multi-axis hose connector assembly of claim 1, further comprising:
a gasket member disposed within each housing and bearing against said first captive ball and said second captive ball;
said gasket member forming a water tight seal that prevents leakage of fluid from said continuous and sealed conduit within said range of motion.

3) The multi-axis hose connector assembly of claim 1, wherein said first connector end further comprises a male threaded member having a tubular body with exterior threads.

4) The multi-axis hose connector assembly of claim 1, wherein said second connector end further comprises a female threaded member having a tubular body with interior threads

5) The multi-axis hose connector assembly of claim 1, wherein the inner end of said first housing and said second housing further comprises a tapered opening.

6) The multi-axis hose connector assembly of claim 1, wherein the outer open end of said first captive ball and said second captive ball further comprises a tapered opening.

7) The multi-axis hose connector assembly of claim 1, wherein said first housing and said first connector end are threadably secured.

8) The multi-axis hose connector assembly of claim 1, wherein said second housing and said second connector end are threadably secured.

9) The multi-axis hose connector assembly of claim 1, wherein:
said first end of said tube member is threadably secured to the inner open end of said first captive ball;
said second end of said tube member is threadably secured to the inner open end of said second captive ball.

10) The multi-axis hose connector assembly of claim 1, wherein:
a portion of said first captive ball and said second captive ball being exposed from the inner end of said first housing and said second housing;
the inner end of said first housing and said second housing having a diameter;
each diameter limiting the range of motion of each captive ball.
